(19) United States
(12) Patent Application Publication
(10) Pub. No.: US 2013/0127616 A1
(43) Pub. Date: May 23, 2013

(54) METHOD AND SYSTEM FOR MONITORING PRESENCE OF PERSONS AT A PHYSICAL LOCATION

(71) Applicant: Cyril ROBITAILLE, La Prairie (CA)

(72) Inventor: Cyril ROBITAILLE, La Prairie (CA)

(21) Appl. No.: 13/682,307

(22) Filed: Nov. 20, 2012

Related U.S. Application Data
(60) Provisional application No. 61/562,087, filed on Nov. 21, 2011.

(51) Int. Cl. G08C 17/02

(52) U.S. Cl. CPC G08C 17/02
USPC 340/539.13

(57) ABSTRACT

The present disclosure relates to a method and a system for monitoring presence of persons at a physical location. A radiofrequency identification ultra-high frequency (RFID-UHF) signal emitted without intervention by a RFID-UHF tag carried by a person is received at the physical location. The person is identified using a code received in the RFID-UHF signal. Presence information of the person is logged in a database. An example of a physical location comprises a school bus or chartered bus. Passive RFID-UHF tags are carried by students or travelers getting on and leaving the bus. A RFID reader detects the students or the travelers as they enter and leave the bus. Presence information of each student or traveler may be confirmed by an operator in order to correct or overcome any false or missing identification. The presence information may be transmitted, for example via cellular transmission, to a remote server.

### TECHNICAL FIELD

The present disclosure relates to the field of presence monitoring. More specifically, the present disclosure relates to a method and a system for monitoring presence of persons at a physical location.

### BACKGROUND

Radiofrequency identification (RFID) technology is commonly used to identify vehicles or goods, present at a given location. An RFID device, oftentimes called a “tag”, is associated with an object being tracked. An RFID reader detects the RFID device when in close proximity. Most RFID systems associate a specific identification code to each RFID device and provide a list of valid identification codes at the RFID reader, or in a database connected to the reader, allowing real-time monitoring of the RFID device.

RFID technologies include active and passive technologies. Each of these technologies comprises its own advantages and drawbacks.

In active RFID systems, each RFID device comprises a source of power, for example a battery, and is capable of emitting a fairly strong signal capable of reaching an RFID reader distant by several meters. One example of use for this technology consists of transponders installed in cars and other vehicles, allowing their detection when passing on toll bridges. This type of RHD device is quite expensive, requires complex maintenance, is difficult to manage, and is not readily usable in applications where they may easily be lost or broken.

Passive RFID systems mainly rely on the use of inexpensive short activation range RFID “tags”. These tags do not carry any autonomous power source; this is the reason why this technology is called “passive RFID”. Those passive REID tags comprise an antenna and an electronic chip storing an identification code. When the passive RFID tag is brought in close proximity to an RFID reader, its antenna detects an electromagnetic field emitted by the reader. This electromagnetic field is turned into a second amount of electrical power, sufficient to energize the chip. The passive RFID tag emits the identification code that is then received in the RFID reader. Passive RFID tags are very inexpensive to manufacture and may be made in very small sizes, often times significantly smaller than a credit card.

However, despite its name, these passive REID requires active manual intervention for proper operation by the user. A user of a passive REID tag may need to bring the tag within a mere few centimeters of an REID reader, for example within two to five centimeters from the reader, in order for the tag to be energized for detection by the reader. This manual intervention takes time and may not be practical in some applications. The term “passive” as applied to REID technology thus designates a manner of providing power to a tag, and not a manner of using the tag.

Therefore, there is a need for a presence monitoring technique that is at once inexpensive and does not require any intervention from a person carrying a passive RFID UHF tag.

### SUMMARY

According to the present disclosure, there is provided a method of monitoring presence of persons at a physical location. A radiofrequency identification ultra-high frequency (RFID-UHF) signal emitted by a RFID-UHF tag carried by a person is received at the physical location. The RFID-UHF signal is emitted without intervention from the person. The person is identified using a code received in the RFID-UHF signal. Presence information of the person is logged in a database.

According to the present disclosure, there is also provided a system for monitoring presence of persons at a physical location. The system comprises a radiofrequency identification ultra-high frequency (RHD-UHF) reader at the physical location for receiving a RFID-UHF signal emitted by a RFID-UHF tag carried by a person. The RFID-UHF signal is emitted without intervention from the person. The system also comprises a database communicatively coupled with the RFID-UHF reader. The database stores a plurality of personal codes. The database also identifies the person by matching a code received in the RFID-UHF signal with a corresponding personal code. The database further logs presence information of the person.

The foregoing and other features will become more apparent upon reading of the following non-restrictive description of illustrative embodiments thereof, given by way of example only with reference to the accompanying drawings.

### BRIEF DESCRIPTION OF THE. DRAWINGS

Embodiments of the disclosure will be described by way of example only with reference to the accompanying drawings, in which:

FIG. 1 is a sequence diagram showing steps of a method of monitoring presence of persons at a physical location according to an embodiment;

FIG. 2 is a sequence diagram showing steps of a method of monitoring presence of children in a school bus according to another embodiment;

FIG. 3 is a block diagram of a system for monitoring presence of persons at a physical location according to a further embodiment;

FIG. 4 is an example of a display for showing images of children at a bus stop; and

FIG. 5 is an example of RFID-UHF reader antenna configuration within a school bus.

### DETAILED DESCRIPTION

Various aspects of the present disclosure generally address one or more of the problems associated with monitoring presence of persons in a physical location.

More specifically, in a first aspect, the present disclosure uses radio-frequency identification (RFID) technology in an ultra high frequency (UHF) band to identify persons in a given physical location. Each person carries a RFID UHF tag while the physical location comprises an RFID UHF reader capable of detecting a presence of the persons carrying the RFID UHF tags. Using RFID-UHF tags allows detecting persons within a radius of several meters. Detection is made without intervention or specific action required on the part of the person carrying the RFID UHF tag. Presence information of detected persons is logged in a database.

In a second aspect, passive RFID-UHF technology may be complemented by operator actions in order to attain an excellent monitoring performance. The operator may validate, or confirm, identities of persons, whether their presence is detected or not. In an aspect, logging of the presence information may be automatic in cases where persons are identified via detection of their RFID UHF tags. The operator may then intervene and validate, or confirm, presence of persons who forgot their RFID UHF tags or whose tags are undetected for any reason. An excellent hit rate may be attained with a monitoring system using RFID-UHF detection incorporating operator validation capabilities.

In a third aspect, an application of the passive RFID-UHF technology may be used for identifying children climbing into or leaving a school bus. Each child carries a passive RFID UHF tag. An RFID UHF reader installed in the school bus detects movements of the children as they get on or off the bus. Verification may be made that each child gets on or off the bus at the proper bus stop, and that no child is missing. An operator may also confirm the absence of a child, react to the entry of a child at a wrong bus stop or to the absence of a RFID UHF tag on a person,

The following terminology is used throughout the present disclosure:
Physical location: as used herein, a physical location is a fixed or mobile place where a person may be located.
RFID: identification technology using an identification code transmitted over a radio interface.
UHF: frequency band from 300 to 3000 MHz, according to current regulatory definitions.
Passive RFID UHF Tag: small portable device; as used herein, a tag is a passive RFID UHF device.
Intervention: conscious action taken by a person.
Presence information: indication that a person is present at a physical location, or absent from the physical location.
Operator: a person taking action on a system.
Validation/confirmation: data verification by an operator.
Remote server: system, such as a computer, remotely connected to another system.
Wireless connection: Radio communication interface, any radio communication capability, including cellular, WiFi, and the like.
Short message/SMS: brief text message sent to or received from a cellular terminal (SMS: short message service).
Email: text message sent to or received from a computer, or a mobile computer, including a personal phone, tablet, and similar devices.
Position information: geographical coordinates or street coordinates with a GPS device or similar device.
Real-time: used to refer to a numerical processing being performed while a physical process, which is a subject of the numerical processing, is actually taking place.
Circular antenna: omnidirectional antenna capable of detecting a signal from a wide angle.
Directional antenna: antenna capable of detecting a signal from a narrow angle.
Correctly receive: receive a signal with sufficient quality to decode its content without error.
Ignore: not receiving a signal or receiving a signal that is too weak for proper reception.

Long rang passive RFID tags have been developed to increase identification ranges. They use the UHF bandwidth. They have until now been used mainly to identify and track goods, vehicles and other objects. The present disclosure uses passive RFID-UHF tags in a context of identifying or tracking persons in vehicles and/or other controlled zones.

Long range passive RFID UHF systems rely on the use of inexpensive passive RFID UHF “tags” that do not carry any autonomous power source; this is the reason why this technology is called “passive RFID”. A passive RFID UHF tag comprises an antenna and an electronic chip storing an identification code, When the RFID UHF tag is brought in a range between one (1) and ten (10) meters of an RFID UHF reader, depending of the type and configuration of the RFID-UHD tag antenna, the RFID-UHF tag internal antenna detects an electromagnetic field emitted by the RFID UHF reader. This electromagnetic field is turned into a small amount of electrical power, sufficient to energize the chip. The passive RFID UHF tag emits an identification code that is received in the RHD reader. Passive RHD UHF tags are very inexpensive to manufacture and may be made in very small sizes, often times significantly smaller than a credit card.

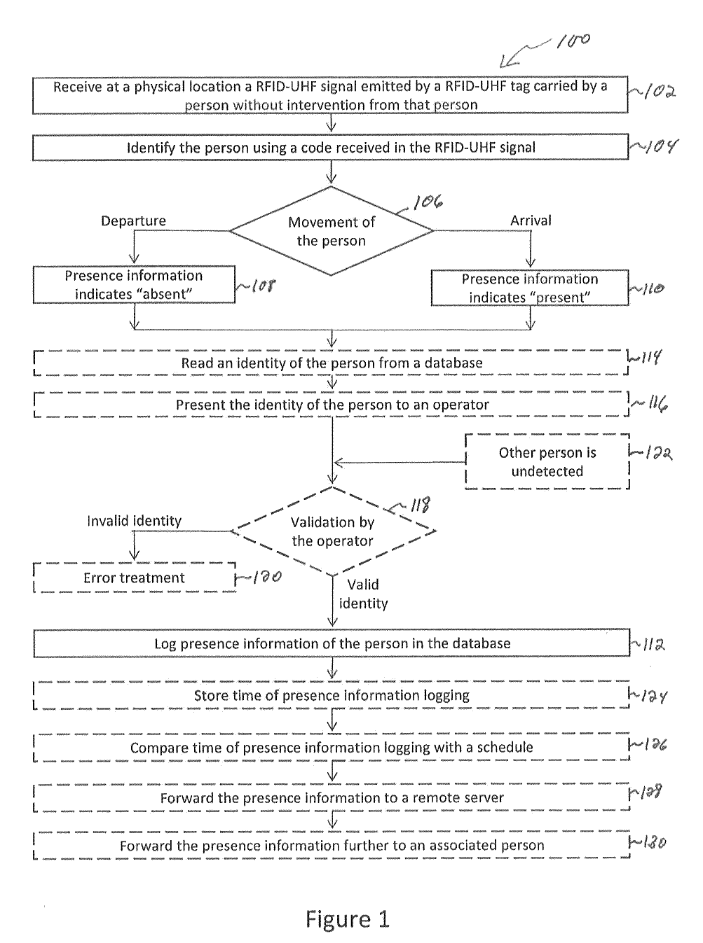

Referring now to the drawings, FIG. 1 is a sequence diagram showing steps of a method of monitoring presence of persons at a physical location according to an embodiment. A sequence 100 begins at step 102 when a radiofrequency identification ultra-high frequency (RFID-UHF) signal, emitted by a passive RFID-UHF tag without intervention from a person carrying the passive RFID-UHF tag, is received at the physical location. The person is identified at step 104 using a code received in the passive RFID-UHF signal. A test may be made at step 106 to determine whether the person is arriving at or departing from the physical location. Depending from a result of the test, presence information may be set to indicate that the person is absent from the physical location, at step 105, or present, at step 110. The presence information of the person is logged in a database at step 112.

Steps 102-112 of the method of monitoring presence of persons at the physical location provide a high level of detection reliability. Some applications may require even higher detection reliability. A variant of the method comprises additional steps, as follows. At any time after step 104, an identity of the person may be read from a database at step 114, using the code received in the RFID-UHF signal. The read identity may then be presented to an operator at step 116. The operator may validate, or confirm, the person's identity at step 118. Logging of the presence information for the person at step 112 may then follow the validation of step 118. In case the operator cannot validate the person's identity at step 118, treatment of an error condition may follow at step 120.

Depending on the application, the treatment of the error condition may comprise any one of a further verification of the person's identity, a denial of access to the physical location, and the like. As a non-limiting example, the code received in the RFID-UHF signal of step 104 may comprise an admission ticket for an event such as a hockey game or a concert. In this example, logging the presence information of the person in the database may comprise validating entry of the person at the event. In case of failure of the validation step, the error treatment of step 120 may comprise verifying a credit card of the person to determine whether or not that person has indeed paid for admission at the event.

A person may not be detected upon arrival or departure from the physical location. This may be caused by any number of reasons, including the person having lost or forgotten his/her passive RFID-UHF tag, the person attempting an unauthorized access at the physical location, or any one of a variety of other reasons. Regardless of the reason, when proper detection of a passive RFID-UHF tag of a person is not made at step 122, the operator may validate or confirm the identity of that person at step 118, using information from the database. The operator may log that person's presence information at step 112 or perform an error treatment at step 120, for example by denying access to the physical location. If the person that could not be detected by means of a passive RFID-UHF tag is accepted, validating the person information manually from the database will confirm his/her presence. Manual entry may for example be made using a keyboard or a touch-sensitive screen operably connected to the database.

Further variants of the embodiment of FIG. 1 may comprise optional features. For example, at step 124, the database may store a time when presence information for a given person is logged in the database. Then at step 126, a comparison may be made between the time of logging the presence information and a schedule at which some event is planned to occur for example a time of arrival of a delivery person at a collection point. Therefore, the method of monitoring presence of persons at a physical location may be used for demonstrating adherence to a planned schedule. In another example of a variant, the database may forward the presence information to a remote server at step 12$, for example using a wireless connection between the database and the remote server. The remote server may then forward again the presence information to a second person associated with the person at step 130. As a non-limiting application example, presence information about a delivery person may be forwarded to another person in charge of delivery schedules.

The method of monitoring presence of persons at a physical location may be used for a broad range of applications, including for monitoring access to a vehicle, access into a boarding gate at an airport, access to a work site, and the like.

In particular, the sequence 100 may be applied as described hereinabove for identification of children transiting to and from school in a school bus, or for identification of travelers getting on or leaving a chartered bus. In such applications, the persons of steps 102-128 may be children or travelers, the associated person of step 130 may be a parent of a child transiting in the school bus, and the physical location where RFID-UHF technology is employed may be an interior of the school bus or of the chartered bus. The operator may be a driver of the bus or an assistant.

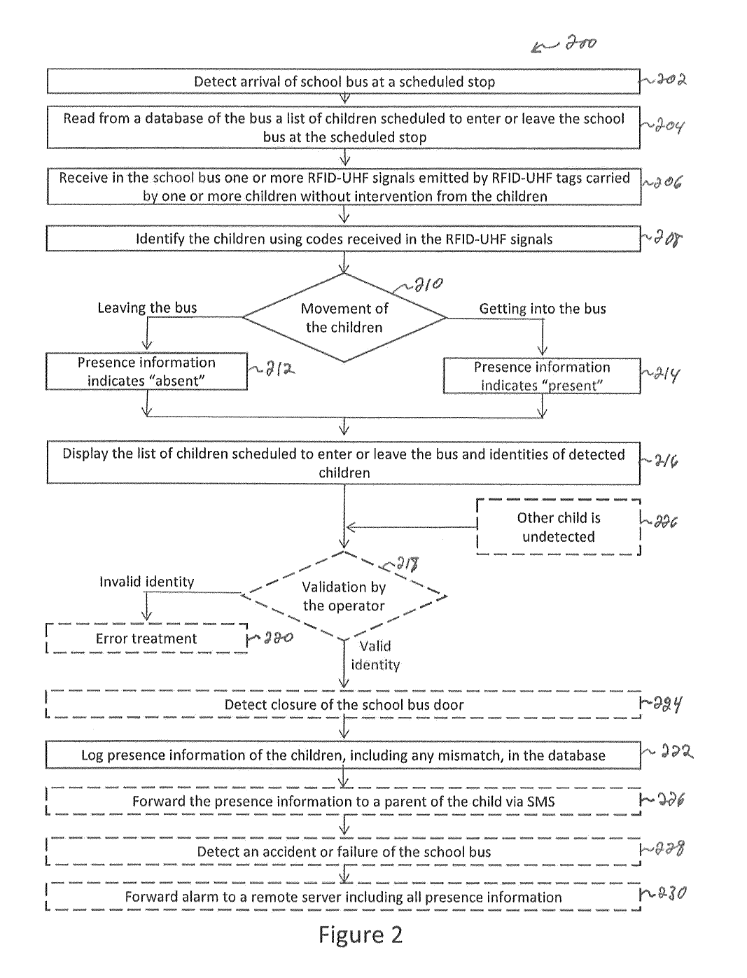

In another embodiment, a modified sequence having particular steps tailored for a child transportation applications may be used. FIG. 2 is a sequence diagram showing steps of a method of monitoring presence of children in a school bus according to another embodiment. Some of the steps of a sequence 200 of the method of monitoring presence of children in a school bus are optional and may or may not be present in one variant or another.

The sequence 200 starts at step 202 when arrival of the school bus at a scheduled stop is detected, for example with the assistance of a global positioning system (GPS) receiver mounted in the school bus. A list of one or more children scheduled to enter or leave the school bus at the scheduled stop is read from a database installed in the school bus at step 204. At step 206, one or more RFID-UHF signals emitted without intervention by RFID-UHF tags carried by one or more children is received in the school bus. Otherwise stated, the children do not need to handle their RFID-UHF tags that may remain in their pockets or in their schoolbags. Each child is identified at step 208 using codes received in the passive RFID-UHF signals. A test may be made at step 210 to determine whether each child is getting into or leaving the school bus. One possible manner of implementing the test of step 210 is to verify whether or not the child was earlier present in the school bus, according to the database. Because a child may be detected multiple times while present in the bus, the test of step 210 may optionally be made at times when a front door of the school bus is open. Depending from a result of the test, presence information may be set to indicate that each child is absent from the school bus, at step 212, or present, at step 214.

At step 216, a list of children scheduled to enter or leave the school bus is displayed, along with identities of the detected children. Passive RFID UHF tags are automatically validated within the database. If no passive RFID UHF tag is detected, the driver may validate presence of a child when entering or leaving the school bus. When the bus door closes, the driver may further verify any discrepancy between the list of children scheduled to enter or leave the school bus at that particular bus stop against those who were not validated or detected. Detection of the bus door closing is optional and the operator may perform verification independently of any door detection. Other error treatment may take place at step 220. For example, a child may be told that he/she is attempting to get on the wrong bus, that he/she is attempting to leave at the wrong stop, that he/she forgot to leave the bus when arriving at home, and the like. Logging of the presence information of each child whose movement in or out of the bus has been detected, and logging of any mismatch between the list of children scheduled to get onto or to leave the school bus at the stop and identities of those who have actually got on or left the school bus, is made at step 222. Optionally, the logging step 222 may follow a detection of closure of the school bus front door at step 224.

If a child gets onto the school bus or leaves the school bus without being detected, at step 226, the operator may validate that the child's movement in or out of the bus is consistent with the list of children for the scheduled stop and manually enter the presence information in the database at step 222, or treat the error at step 220.

Some variants of the method of monitoring presence of children in a school bus may enhance the safety of the children and reassure their parents of the whereabouts of their children. In an option, presence information of a child may be forwarded to a parent at step 224, for example by sending a short message (SMS) to a cellular terminal of the parent or an Email to any address of the parent. This may be accomplished by forwarding wirelessly the presence information from the database of the school bus to a remote server, possibly installed at a school board or at a school transportation company, and then by initiating sending of the SMS or Email at the remote server. In another option, a SMS or Email may be sent to a parent indicating that the school bus is nearing a scheduled stop for that parent's child, indicating that the school bus is late, and the like. In a further option, in case of an accident or a failure of the school bus detected at step 228, an alarm comprising a time of the accident, position information of the school bus and a list of children present in the school bus may be forwarded to the remote server for transfer to an emergency services authority. In yet another option, vehicle information may be obtained from an internal Controller Area Network bus (CANBUS) vehicle interface. The vehicle information may be sent to the remote server for analysis. Non-limiting examples of vehicle information may comprise a speed of the vehicle, an engine RPM, tracking of the route, passing on a railroad track without stopping, and the like. These information elements may be analyzed for safety or driver efficiency evaluation,

The steps of the method of monitoring presence of children in a school bus of FIG. 2 may be adapted slightly to provide a method of monitoring presence of travelers in a chartered bus. A database in the chartered bus may comprise a list of all travelers and the method may be used to ensure that no traveler is left behind when the bus continues its route following a stop along the road.

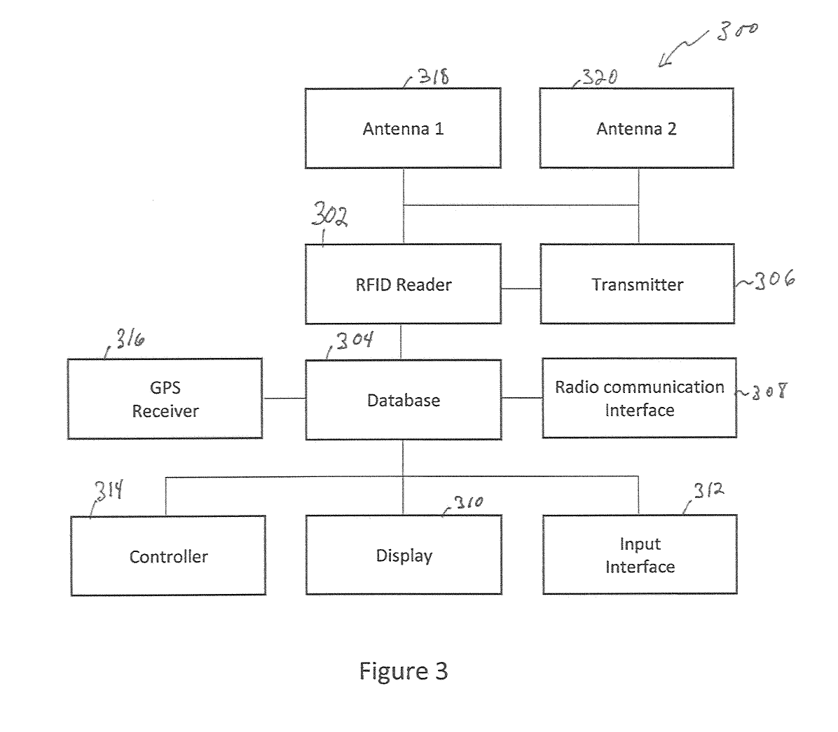

FIG. 3 is a block diagram of a system for monitoring presence of persons at a physical location according to a further embodiment. A system 300 installed at a physical location where presence verification is to be made may comprise several components, some of which are optional and may not be present in all implementations. A RFID-UHF reader 302 with one or multiple antennas, capable of receiving RFID-UHF signals emitted without intervention by a passive RFID-UHF tags (not shown), is communicatively coupled with a database 304. The database 304 stores a plurality of personal codes and is capable of identifying a person by matching a code received in a RFID-UHF signal with a corresponding personal code. The database 304 logs presence information for persons detected by the RFID-UHF reader 302. The RFID-UHF reader 302 may comprise, or be coupled to, a RFID UHF transmitter 306 used for activating passive RFID-UHF tags. The system 300 may also comprise a radio communication interface 308, for example a cellular terminal or WiFi, allowing forwarding the presence information from the database 304 to a remote server. A display 310 may allow presentation to an operator of an identity of a person based on a corresponding personal code read from the database 304 While an input interface 312 may be used by the operator for confirming the identity of the person. A controller 314 coupled to the database 304, the display 310 and the input interface 312 may then control logging of the presence information of the person in the database 304 based on the confirmation of the identity of the person. The RFID-UHF reader 302 and the RFID-UHF transmitter 306 may have internal antennas or may be coupled to an antenna 318 or to more than one antenna, including antennas 318 and 320,

In a variant, the physical location may be mobile, for example within a vehicle used for public transportation. The system 300 may comprise a global positioning system (GPS) receiver 316 for providing real-time coordinates of the physical location. The GPS receiver 816 provides the coordinates to the database 304 for storing, along with the presence information of the person, a time stamp and the coordinates of the physical location at a time of storing of the presence information.

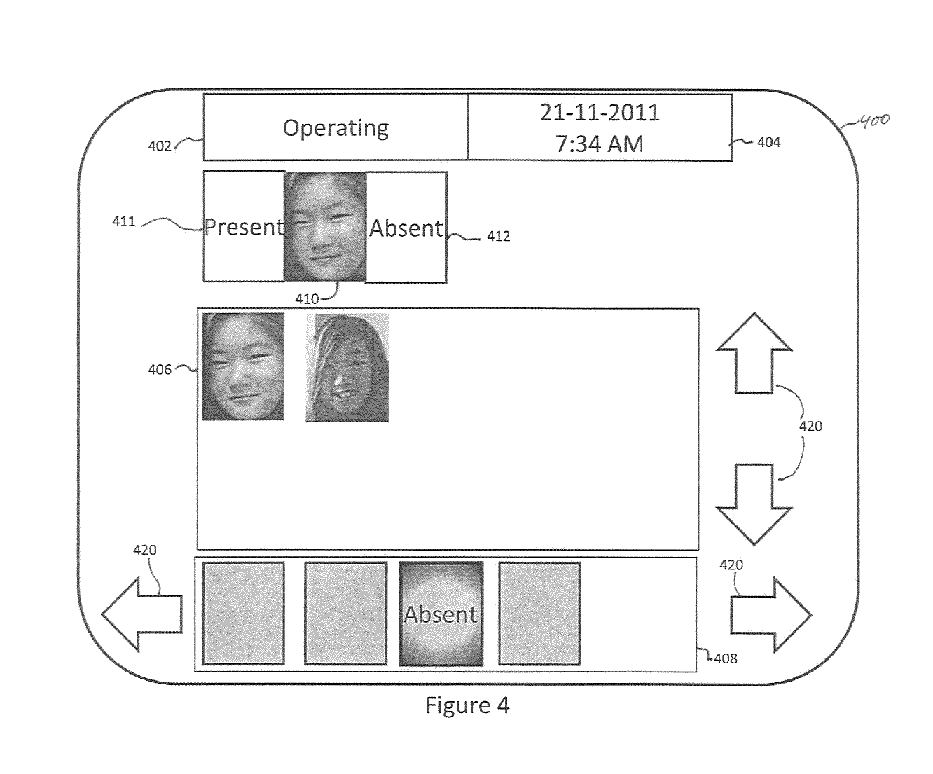

FIG. 4 is an example of a display for showing images of children at a bus stop. The display 310 and the input interface 312 of FIG. 3 may be realized as a touch-sensitive screen 400 having a display capability for presenting images of one or more persons and an input capability for accepting an operator selection of an image of a person for confirming the person's identity. The touch-sensitive screen 400 shows a variety of fields including a status field 402, a clock 404 and pictures of a list 406 of children who are scheduled to get into a school bus at a scheduled stop. When the system 300 detects RFID-UHF tags of the children, their pictures are from the list 406 moved to a field 408 of children whose presence or absence has been detected or validated. A picture of a child who is detected may be moved automatically, without operator intervention, to the field 408. When a given child is not detected at the scheduled stop, his/her picture is moved to a validation field 410. The operator may validate the presence status for the child by selecting on the touch-sensitive screen 400 a “present” field 411 or an “absent” field 412. In a variant, the picture of the validation field 410 may be moved into the field 408 with distinct highlighting depending on whether the child is present or absent. The operator may use arrows 420 for navigating through the pictures 406, for example at stops where many children are scheduled to get in or out of the bus, of through the field 408. Those of ordinary skill in the art having the benefit of reading the present disclosure will be able to design variations of the fields shown on the touch-sensitive screen 400.

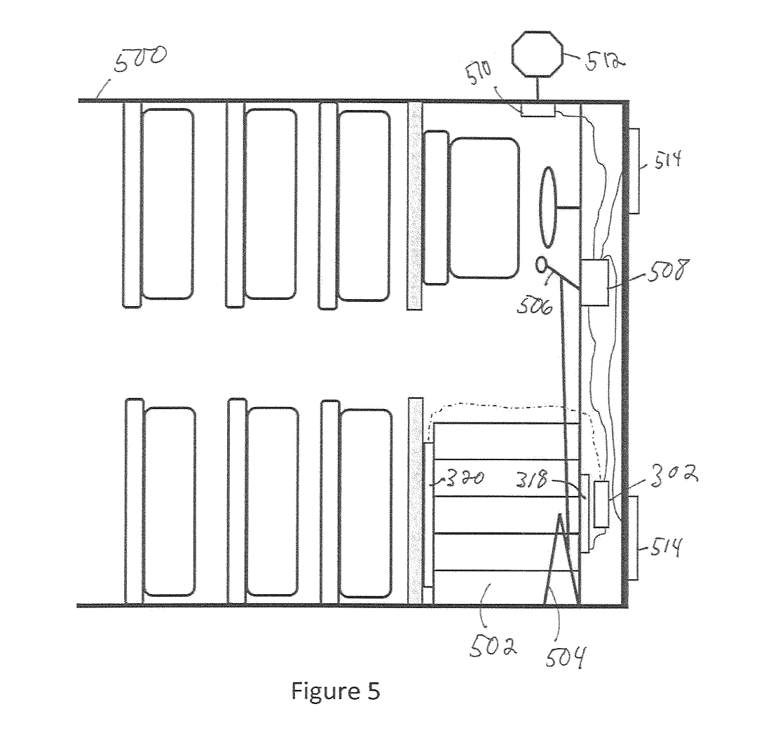

FIG. 5 is an example of RFID-UHF reader antenna configuration within a school bus. A partial top plan view of a school bus 500 shows a placement of various components of the system 300. In the shown embodiment, the RFID UHF transmitter 306 is integrated into the RFID-UHF reader 302 while a single terminal 508 incorporates the database 304, the radio communication interface 308, the controller 314, the GPS receiver 316 and the touch sensitive screen 400. In a non-limiting example, the terminal 508 may be a R05I98H-RTD1 handheld device from Winmate, in which features supporting the above describe methods are implemented.

The antenna 320 may be a circular antenna oriented towards the back of the vehicle while the antenna 318 may be directional antenna facing the antenna 320. Placing both antennas 318 and 320 on either side of stairs 502 at an entry point of the school bus 500 provides an excellent level of detectability of the passive RFID-UHF tags worn by the children, whether in their pockets on in their schoolbags. It is possible to adjust a sensitivity of the RFID-UHF reader 302 and configuration of the circular and directional antennas 318 and 320 to correctly receive with a probability greater than 97 percent a signal from a passive RFID-UHF tag located within the access path while ignoring signals from passive RFID-UHF tags located outside the vehicle.

The terminal 508 is connected to the RFID-UHF reader 302, which is further connected to the antennas 318 and 320. In an embodiment, the terminal 508 may further be connected to a detector (not shown) of a handle 506 of controlling a front door 504 of the school bus 500, enabling the terminal 508 to detect a position of the front door 504. The terminal 508 may further be connected to a control 510 of a movable stop sign deployed when children access and leave the school bus. The terminal 508 may additionally be connected to red lights 514 that flash when children access and leave the school bus. The terminal 508 may also be connected to a CANBUS interface enabling the terminal 508 to track vehicular information. Connection of the terminal 508 to the handle 506, to the control 510 and to the lights 514 allow a synchronization of children detection with moments when children should indeed be moving in and out of the school bus 500.

FIG. 5 illustrates one of many possible antenna configurations. Other configurations may be desirable depending on a shape, structure and format of a physical location or, more specifically, of a vehicle. For example, a city bus may comprise a front door for getting on or leaving the bus and a rear door solely used for leaving the bus. Antennas may be positioned for detection of persons using both doors.

Those of ordinary skill in the art will realize that the description of the system and method for monitoring presence of persons at a physical location are illustrative only and are not intended to be in any way limiting. Other embodiments will readily suggest themselves to such persons with ordinary skill in the art having the benefit of the present disclosure. Furthermore, the disclosed system and method may be customized to offer valuable solutions to existing needs and problems of monitoring presence of persons at a physical location.

In the interest of clarity, not all of the routine features of the implementations of the system and method for monitoring presence of persons at a physical location are shown and described. It will, of course, be appreciated that in the development of any such actual implementation of the system and method, numerous implementation-specific decisions may need to be made in order to achieve the developer's specific goals, such as compliance with application-, system-, network- and business-related constraints, and that these specific goals will vary from one implementation to another and from one developer to another. Moreover, it will be appreciated that a development effort might be complex and time-consuming, but would nevertheless be a routine undertaking of engineering for those of ordinary skill in the field of presence verification having the benefit of the present disclosure.

In accordance with the present disclosure, the components, process steps, and/or data structures described herein may be implemented using various types of operating systems, computing platforms, network devices, computer programs, and/or general purpose machines. In addition, those of ordinary skill in the aft will recognize that devices of a less general purpose nature, such as hardwired devices, field programmable gate arrays (FPGAs), application specific integrated circuits (ASICs), or the like, may also be used. Where a method comprising a series of process steps is implemented by a computer or a machine and those process steps may be stored as a series of instructions readable by the machine, they may be stored on a tangible medium.

Systems and modules described herein may comprise software, firmware, hardware, or any combination(s) of software, firmware, or hardware suitable for the purposes described herein. Software and other modules may reside on servers, workstations, personal computers, computerized tablets, personal digital assistants (PDA), and other devices suitable for the purposes described herein. Software and other modules may be accessible via local memory, via a network, via a browser or other application or via other means suitable for the purposes described herein. Data structures described herein may comprise computer files, variables, programming arrays, programming structures, or any electronic information storage schemes or methods, or any combinations thereof, suitable for the purposes described herein.

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. A method of monitoring presence of persons at a physical location, comprising;
receiving at the physical location a radiofrequency identification ultra-high frequency (RFID-UHF) signal emitted by a RFID-UHF tag carried by a first person, wherein the RFID-UHF signal is emitted without intervention from the first person;
identifying the first person using a code received in the RFID-UHF signal; and
logging presence information of the first person in a database.

2. The method of claim 1, wherein the RFID-UHF signal is received upon arrival at the physical location by the first person.

3. The method of claim 1, wherein the RFID-UHF signal is received upon departure from the physical location by the first person.

4. The method of claim 1, comprising:
the presence information indicates either that the first person is present at the physical location or that the first person is absent from the physical location.

5. The method of claim 1, comprising;
reading an identity of the first person from the database;
presenting the identity of the first person to an operator;
wherein logging the presence information is conditional upon receiving from the operator a validation of the identity of the first person.

6. The method of claim 5, comprising:
manually entering in the database, by the operator, presence information of a third person in the absence of a RHD-UHF signal related to the third person.

7. Use of the method of claim 5 for demonstrating adherence to a planned schedule.

8. The method of claim 1, comprising forwarding the presence information from the database to a remote server.

9. The method of claim 8, wherein the database communicates with the remote server via a wireless connection.

10. The method of claim 8, comprising forwarding the presence information from the remote server to a second person associated with the first person.

11. The method of claim 1, wherein:
the physical location is in a school bus;
the first person is a child entering or leaving the school bus; and
the database is located in the school bus.

12. The method of claim 11, comprising:
detecting arrival of the school bus at a scheduled stop;
reading from the database a list of one or more children scheduled to enter or leave the school bus at the scheduled stop;
detecting each child entering or leaving the school bus;
comparing the list with detections of the children having entered or left the school bus; and
logging in the database any mismatch between the list and detections of the children.

13. The method of claim 12, wherein logging any mismatch follows detecting a closure of a door of the school bus.

14. The method of claim 11 comprising forwarding the presence information from the remote server via short message (SMS) or Email to a cellular terminal or computer of a parent of the child.

15. The method of claim 11, comprising:
detecting an accident or a failure of the school bus; and
forwarding to a remote server an alarm comprising a time of the accident, position information of the school bus and a list of children present in the school bus.

16. The method of claim 1, wherein:
the code comprises an admission ticket for an event; and
logging the presence information of the first person in the database comprises validating entry of the first person at the event.

17. A system for monitoring presence of persons at a physical location, comprising:
a radiofrequency identification ultra-high frequency (RFD-UHF) reader at the physical location for receiving a RFID-UHF signal emitted by a RFID-UHF tag carried by a person, wherein the RFID-UHF signal is emitted without intervention from the person; and
a database communicatively coupled with the RFID-UHF reader for storing a plurality of personal codes, for identifying the person by matching a code received in the RFID-UHF signal with a corresponding personal code, and for logging presence information of the person.

18. The system of claim 17, comprising a UHF transmitter for activating the RFID-UHF tag carried by the person.

19. The system of claim 17, comprising a radio communication interface for forwarding the presence information from the database to a remote server.

20. The system of claim 17, comprising:
a display for presenting, to an operator, an identity of the person based on the corresponding personal code;
an input interface for receiving from the operator a confirmation of the identity of the person; and
a controller for controlling the logging of the presence information of the person in the database based on the confirmation of the identity of the person.

21. The system of claim 20, comprising:
a touch-sensitive screen comprising a display capability for presenting images of one or more persons and an input capability for accepting an operator selection of an image of a person for confirming the person's identity.

22. The system of claim 17, wherein:
the physical location is mobile;
the system comprises a global positioning system (GPS) receiver for providing real-time coordinates of the physical location; and
the database is further capable of storing, along with the presence information of the person, a time stamp and coordinates of the physical location at a time of storing of the presence information.

23. The system of claim 17, wherein:
the RFID-UHF reader comprises two antennas positioned on either sides of an access path of a vehicle, including a first circular antenna oriented towards the back of the vehicle and a second directional antenna facing the first circular antenna.

24. The system of claim 23, wherein:
the first circular antenna and the second directional antenna are configured to correctly receive with a probability greater than 97 percent a signal from a RFID-UHF tag located within the access path.
